(19) United States
(12) Patent Application Publication
(10) Pub. No.: US 2018/0334808 A1
(43) Pub. Date: Nov. 22, 2018

(54) Slip Resistant Sheet Material with Temporary Adhesion to a Contact Surface

(71) Applicant: Specialty Coating & Laminating, LLC, Doswell, VA (US)

(72) Inventors: Geoffrey M. Baldwin, Mechanicsville, VA (US); Joshua A. Elliott, Henrico, VA (US); Rickey J. Seyler, Chesterfield, VA (US)

(73) Assignee: Specialty Coating & Laminating, LLC, Doswell, VA (US)

(21) Appl. No.: 15/983,721

(22) Filed: May 18, 2018

Related U.S. Application Data
(60) Provisional application No. 62/509,069, filed on May 20, 2017.

(51) Int. Cl. E04D 5/06; B32B 27/10; B32B 27/12; B32B 5/02

(52) U.S. Cl. CPC E04D 5/06; B32B 27/10; B32B 27/12; B32B 2419/06; B32B 5/022; B32B 2255/10; B32B 2307/7265; B32B 5/024

(57) ABSTRACT

A multilayer roofing underlayment sheet has a structural sheet layer formed of a flexible layer of fabric or paper or a composite thereof, the structural sheet layer having a top side and a bottom side. First and second water impermeable thermoplastic layers are affixed on the top and bottom sides of the structural layer respectively. A first clean peelable pressure sensitive adhesive coating layer is attached on one of the water impermeable thermoplastic layers on the opposite side of the water impermeable thermoplastic layer from the structural layer. The resulting underlayment sheet is slip resistant and is able to temporarily adhere to a contact surface.

This application claims the benefit of filing of U.S. Provisional Patent Application No. 62/509,069, filed on May 20, 2017, which is incorporated by reference herein in its entirety.

This invention relates to a multilayer sheet material used particularly in the construction trades as a roofing underlayment. Specifically, the sheet material includes a clean peelable, pressure sensitive adhesive coated on one or both sides thereof.

### BACKGROUND

In a typical residential or commercial roof installation with a pitch generally exceeding 3/12 (14° slope), an underlayment material is placed between the decking material and the primary roof covering. Said underlayment provides the first water shedding protection to the interior structure of the building during construction and subsequently becomes a secondary barrier to water penetration to the interior upon installation of the primary roof covering. Typical primary roof coverings include composition shingles, metal panels, concrete or clay tiles, wood shakes, or slate. They provide the long term main water protection barrier of the roof.

The historical choice for roof underlayment, most notably with solid roof decking in the Americas and Europe, has been that of a bituminous asphalt saturated paper felt—felt or tar paper. While providing resistance to water penetration and reasonable walkability, especially in warmer weather, felt materials exhibit a number of disadvantages or deficiencies. These include very low tensile and tear strength, high weight per unit area, high caliper, a propensity to become brittle with age, leach oils, and absorb moisture while exhibiting poor UV resistance, limited flexibility, and as black material it absorbs considerable radiant energy.

A number of alternative underlayment products are now available commercially which are generally referred to as ‘synthetic’ roofing underlayments. These synthetic underlayment products typically consist of a plastic fabric with a water impenetrable coating as a minimum structure. Most commonly the fabric is a woven fabric of narrow polyolefin tapes that is subsequently resin coated with a polyolefin or a polyolefin blend. In some cases a heavy basis weight nonwoven is employed as the fabric. Regardless of the fabric used, synthetic roof underlayment products can be further categorized as requiring mechanical fastening or as self-adhering (or “peel and stick”). The present invention is applicable to synthetic roofing underlayment of either category.

The minimum 2-layer structure of synthetic roof underlayment materials offers superior tensile and tear strength to that of felt rendering them much less prone to ripping and tearing in windy and/or cold weather or when sheared under the weight of an installer after mechanical fastening to the roof deck. In addition, such synthetic underlayment materials offer superior water barrier in a thinner, more flexible, light weight sheet material available in smaller rolls of greater length that are easier to handle on steeper roofs, are easily manipulated to provide excellent lay-flat on the roof decking, and require fewer trips between the roof and the ground. Incorporation of UV stabilizers and light colored pigments insure superior UV stability and lower heat buildup in the primary roof covering for longer service life.

The principle drawback of early 2-layer synthetic roof underlayment materials was that they were too slippery relative to felt. Their low coefficient of friction (COF) reduced walkability rendering their use on steeper roof pitches a safety risk to installers. Next generation synthetic roof underlayment products addressed this shortfall by incorporating slip resistant features that afforded the installer better traction. This was addressed in a number of approaches that ultimately lead to products that improved traction or increased the coefficient of friction on one or both surfaces of the underlayment sheet.

One approach consists of utilizing a more textured surface on the installer contacting surface which created a mechanical gripping surface to promote ‘walkability’ after the synthetic underlayment was mechanically fastened. This mechanical grip could be in the form of a nonwoven fabric with exposed fiber strands or a 3D textured surface such as from mechanical embossing.

An alternative was to incorporate a compatible ingredient to the water impenetrable thermoplastic coating that increased the coefficient of friction (COF) of said coating. One such ingredient is a thermoplastic elastomer; especially an ethylene-propylene copolymer. Increasing the coefficient of friction in the water impenetrable coating either reduced the propensity for the underlayment to ‘slide’ down the roof when said coating is placed on the deck facing side or improved ‘walkability’ for the installer after fastening to the deck when said coating is on the installer facing side.

Nearly all commercial synthetic roofing underlayment products in use today provide slip resistant properties on both the deck facing and installer facing sides of the sheet. Some offer a textured installer facing side combined with a higher coefficient of friction coating on the deck facing side. Others utilize a nonwoven fabric on the installer facing side laminated to a woven fabric that is again backside coated with a slip resistant coating facing the deck. A further approach utilizes mechanical grip on both sides of the sheet such as two layers of nonwoven fabric laminated together. Yet another approach is to utilize a woven fabric coated on both sides with higher coefficient of friction coatings to derive slip resistant performance.

Utilizing the aforementioned slip resistant approaches current synthetic roofing underlayment products have overcome the primary deficiency of earlier generation products. In all of the examples referenced above where a higher coefficient of friction slip resistant coating is utilized it is a continuous layer. Said coating could be applied as a single layer or multiple layers using any state-of-the-art coating application processes. Generally an extrusion coating process is preferred for the application of polyolefin based coatings encountered with most synthetic roofing underlayment products.

Some specific examples of underlayment products include the following.

A skid-resistant self-adhering roofing underlayment comprises multiple layers which include a pressure-sensitive waterproofing membrane on the deck facing surface and a multiply carrier support with corrugated machine direction ridges on the installer facing surface. Said corrugated ridges are composed of polyolefin materials with low coefficient of friction. The pressure sensitive adhesive layer is used both to permanently adhere the underlayment to the deck and create a waterproof coverage. While the adhesive layer is referred to as pressure sensitive, it is necessarily a continuous (100% area coverage) layer to establish water proofing performance, it is intended to deliver permanent bonding, and requires a removable release sheet for storage and application to prevent blocking of the roll.

A reinforced roof underlayment with high tensile strength comprises an interwoven scrim mesh with a waterproof material affixed to at least one face of the scrim and a layer of slip resistant material positioned over an outer surface (installer facing surface) composed of polypropylene. The supposed slip resistant layer is therefore a low coefficient of friction polyolefin which will impart minimal impedance to slip.

A sheet material has a walking surface with high slip resistance accomplished by use of an open mesh layer with protruding nodes at the junction of strands crossing perpendicular to each other. These nodes impart a high degree of mechanical grip attributed as a high coefficient of friction which may be further enhanced by coating these nodes with a tacky material like ethylene vinyl acetate copolymer (EVA). The sheet further claims a high coefficient of friction deck facing layer again composed of ethylene vinyl acetate copolymer. The commercial product Titanium® UDL 30 by InterWrap, Inc is a representative underlayment defined by this example.

### SUMMARY

Accordingly, it is an object of the present invention to overcome the shortcomings of existing roof underlayment sheets. One aspect of this invention stems from the fact that a continuous layer of slip resistant properties is not necessary to meet the requirements placed upon a roofing underlayment. Secondly, the need to achieve adequate ‘grip’ is only temporary during installation of the synthetic underlayment and during installation of the primary roof covering. Once the primary roof covering is installed, the slip resistant properties of the underlayment are inconsequential. More specifically, during installation there is a need to have the underlayment sheet remain where positioned until it is permanently affixed to the deck and a need for the remaining roll of material to remain intact on the roof. Once the underlayment material is fastened, ‘grip’ changes focus to that of slip resistance for ‘walkability’ such that installers can safely move across covered areas of the roof. This requires localized grip under the installers feet only until they are repositioned elsewhere.

Considering the temporary nature of the slip resistant demands on a synthetic roofing underlayment, it would be valuable to have that ‘grip’ be available to the installer as an ‘on demand’ feature such that it would be achieved only when and where pressure was applied to the underlayment while without pressure the material is easily unrolled, positioned, and less prone to attracting loose debris. This has been accomplished by the underlayment sheet described herein by incorporating a ‘clean peelable’ pressure sensitive adhesive as part of the slip resistant coating on at least one side of the woven fabric component of a synthetic roofing underlayment sheet. The pressure sensitive adhesive may be applied to the synthetic underlayment as a neat coating or in combination with another coefficient of friction enhancing ingredient(s) such as acrylic or vinyl polymers. The pressure sensitive adhesive not only increases the coefficient of friction of the polyolefin coated woven fabric but also upon application of compressive force activates to substantially increase slip resistance by creating a temporary adhesive bond to the contacting surface within the area of the applied force. Depending upon which side of the synthetic underlayment the pressure sensitive adhesive is applied this temporary bond can be between the underlayment and the deck; between the underlayment and the installer, equipment or supplies; and between wraps of the underlayment within the unwound roll. ‘Clean peelable’ is defined as being capable of releasing the temporary bond, upon removal of any compressive force, without the transfer of adhesive to the contacted surface. In other words release of the temporary bond occurs with approximately 100% adhesive failure and 0% cohesive failure.

When applied to the deck facing side of the underlayment, the pressure sensitive adhesive will facilitate installation by temporarily adhering the material to the deck wherever the installer applies compressive force to hold the material in place until permanent mechanical fasteners may be applied. This is especially beneficial for installations in breezy conditions or on steeper pitched roofs (greater than 7/12 pitch or 30°) where the unrolled underlayment sheet is readily displaced by the moving air or by gravity. The deck facing pressure sensitive adhesive also facilitates retaining the remaining unwound roll of material unattended on the deck until further unwinding is needed. This is accomplished by both preventing the roll from sliding and unraveling. Once installed, the temporary bonding capability of the pressure sensitive adhesive minimizes the potential for tearing at the mechanical fasteners when walked upon or loaded with supplies and equipment, thereby avoiding any measurable breach in the water barrier provided by the underlayment.

When applied to the installer facing side of the underlayment, the pressure sensitive adhesive will again facilitate installation. ‘Walkability’ is greatly enhanced when an installer steps onto the pressure sensitive adhesive layer activating it to temporarily ‘grip’ the installer rendering movement on the roof faster and safer. Similarly equipment and supplies are held in place until needed and moved, As was the case for the pressure sensitive coating on the deck facing side, if applied to the installer facing side it will also prevent the roll of material from unraveling.

The effective coefficient of friction becomes large when a temporary bond is formed by said pressure sensitive adhesive. Depending upon the adhesive used and the compressive force applied, the ‘grip’ of the coated layer may become excessive resulting in blocking of rolls of the underlayment, would render manufacturing of the web based sheeting difficult, and would hinder easy positioning of the underlayment during installation. Hence it is only necessary to apply the slip resistant coating of this invention over a portion of the underlayment sheet surface. The percentage of area coverage will depend upon the slip resistance performance target required and the adhesive properties of the material(s) used. FIG. 1 illustrates the pattern used for the demonstrations included herein. It consists of a series of close-packed rings with a total area coverage of 25%.

### BRIEF DESCRIPTION OF FIGURES

FIG. 1 is a top view of an underlayment sheet as described herein with the layers shown peeled back in the lower right corner and showing an example pattern of the slip resistant coating on the top surface.

FIG. 2 is a side, cross-sectional view of the underlayment sheet shown in FIG. 1.

FIG. 3 is a bottom view of the underlayment sheet shown in FIG. 1 with the layers peeled back in the lower right corner.

FIG. 4 is a side, cross-sectional view of a second example of an underlayment sheet as described herein.

FIG. 5 is a top view of a third example of an underlayment sheet as described herein with the layers peeled back in the lower right corner.

FIG. 6 is a side, cross-sectional view of the underlayment sheet shown in FIG. 5.

### DETAILED DESCRIPTION

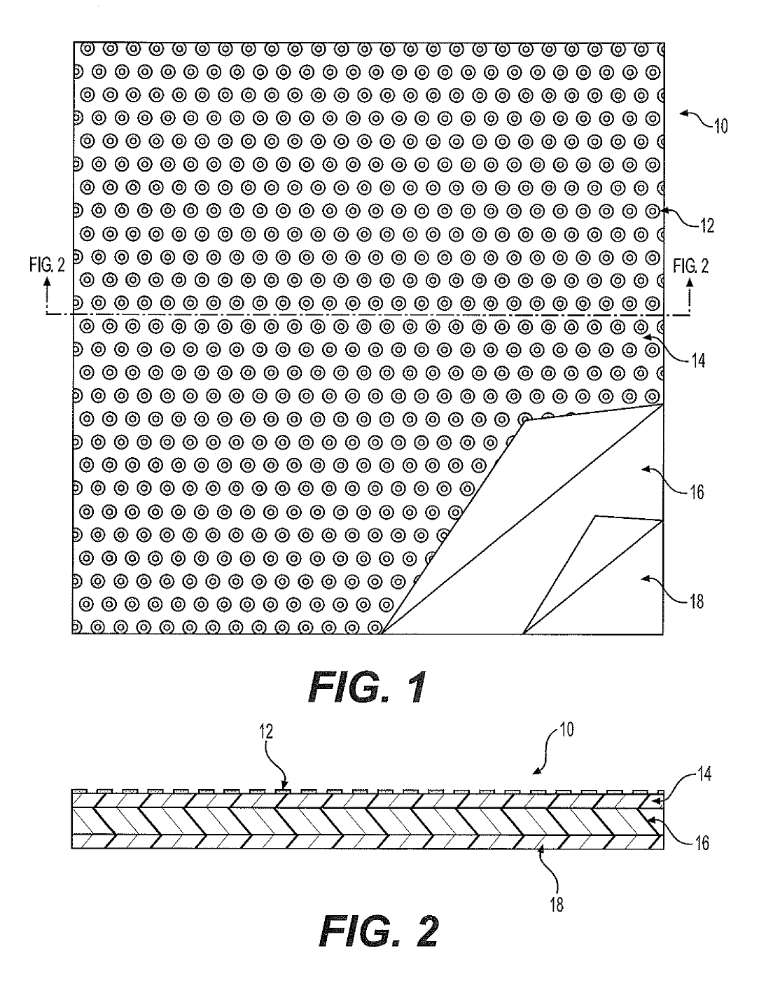

FIG. 1 shows an exemplary synthetic roofing underlayment sheet 10 of this invention wherein a clean peelable pressure sensitive adhesive formulation coating 12 is printed in a graphic pattern (circular rings) onto a continuous water impenetrable thermoplastic layer 14 that is affixed along with a second continuous water impenetrable thermoplastic layer 18 to a structural layer 16. Referring also to FIG. 2, the second thermoplastic layer 18 may consist of a higher coefficient of friction (COF) formulation achieving a COF of 0.60 or more, or alternatively a COF of 1.0 or more. A preferred approach to achieving a higher coefficient of friction in the thermoplastic layer 18 is to coextrude a compatible thermoplastic elastomer, for instance Vistamax from Exxon, with a base polyolefin, for instance a propylene-ethylene copolymer. The structural layer 16 may consist of a woven or nonwoven fabric, or paper, or a composite thereof. It is preferred that the structural layer 16 be a woven fabric comprised of polyolefin tapes at a count of about 3-12 per inch. It is understood that both water impenetrable thermoplastic layers 14 and 18 may be adhered to the woven fabric 16 by any means known in the art. It is preferred that the thermoplastic layers 14 and 18 consist of polyolefin materials that are extrusion coated at about 3-12 lb/MSF onto the woven fabric 16. At least one ingredient in the formulation of the coated slip resistant layer 12 is a clean peelable pressure sensitive adhesive. This formulation is applied to the water impenetrable thermoplastic layer 14 by any means known in the art at a wet coverage equivalent to about 1-6 lb/MSF at 100% area coverage. A preferred application of the slip resistant layer 12 is by printing a graphic pattern with a minimum area coverage of at least 5%, or alternatively an area coverage of between about 10% and 100%, and still further alternatively between about 25% and 80%.

When applied to a roof deck the synthetic underlayment sheet 10 can be placed such that the printed slip resistant pattern 12 is installer facing and the second thermoplastic layer 18 is deck facing. The higher coefficient of friction of the deck facing layer 18 reduces the propensity for the underlayment sheet to slide on a pitched roof during unrolling and until it is permanently affixed to the deck with mechanical fasteners. Once permanently fastened to the deck the underlayment of this invention provides the installer excellent walkability as the clean peelable adhesive of the installer facing layer 12 is activated by the installer's weight to grip the installer by temporarily bonding to the installer. Any object placed onto the applied underlayment will experience this grip within its contact area thereby preventing it from sliding off the pitched roof.

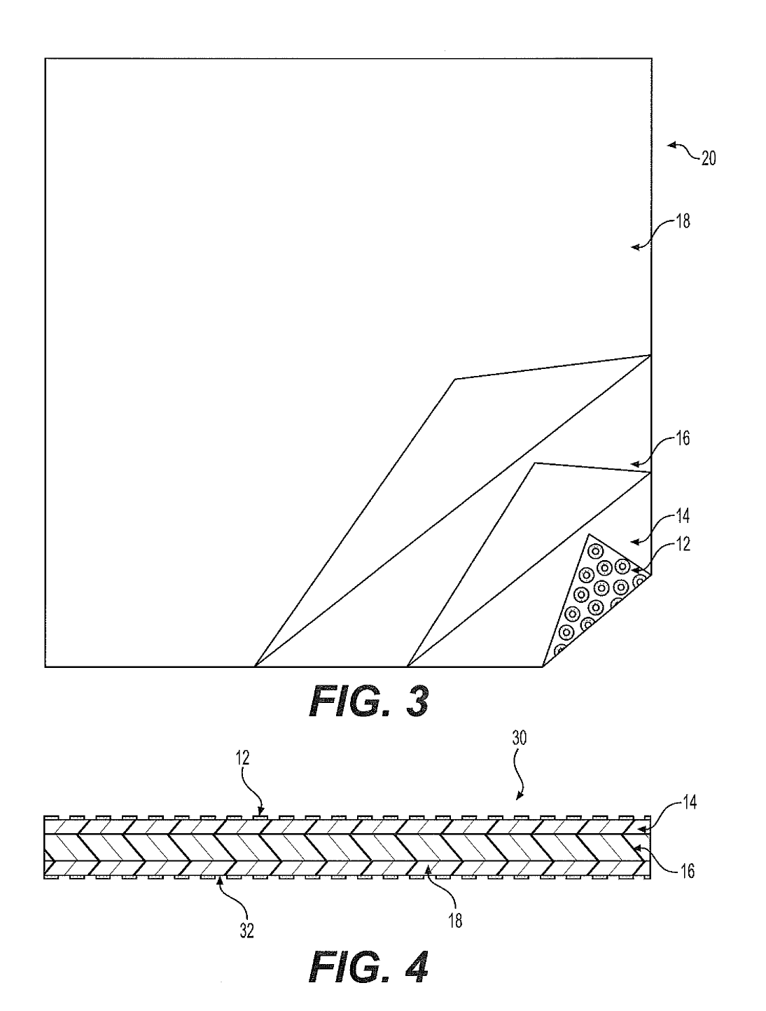

FIG. 3 represents a different underlayment sheet example 20 which represents the equivalent of the underlayment sheet of FIG. 1 except with an inverted cross section such that the slip resistant layer 12 now becomes the deck facing surface and the higher coefficient of friction layer 18 becomes the installer facing surface. This configuration of the invention provides the installer with a novel feature—place and set not available in current products while continuing to offer walkability equivalent to premium products. This ‘place and set’ feature allows the installer to unroll and position the underlayment sheet over the deck and temporarily affix it to the deck so that it remains in position until permanent mechanical fasteners may be applied. The pressure sensitive adhesive component of layer 12 has a higher coefficient of friction at the outset which reduces the propensity for the underlayment to slide down the roof slope during unrolling but not sufficiently high that it inhibits placement adjustments to achieve alignment and lay flat, hence the ‘place’ performance of this underlayment. The ‘set’ is associated with the activation of a temporary bond between the underlayment and the deck when the installer applies a compressive force to the underlayment. This ‘set’ characteristic is particularly valuable to the installer when covering long distances or on steep roofs in excess of 7/12 pitch (30° slope) or in avoiding underlayment displacement by wind. By virtue of utilizing a clean peeling pressure sensitive adhesive in layer 12, the underlayment sheet may readily be repositioned if necessary prior to permanent fastening by applying a slight shear force to release the temporary bonds. An additional benefit of this ‘set’ feature is that stress concentration at mechanical fasteners is measurably reduced when the underlayment experiences shear forces from down slope loading such as when an operator is walking across the underlayment. This reduction in load at the mechanical fastener significantly reduces the potential for tearing that could breach the water barrier provided by layers 14 and 18.

FIG. 4 represents another example underlayment sheet 30 wherein the underlayment is a symmetric cross section element in which both the deck facing surface and the installer facing surface are coated with a clean peelable pressure sensitive adhesive formulation (12 and 32). Underlayment 30 thus offers both the pressure activated grip for excellent walkability, as well as, the ‘place and set’ performance for initial installation afforded by the inclusion of a clean peelable pressure sensitive adhesive. In this embodiment it is not necessary that layer 18 exhibit a higher coefficient of friction than layer 14 and it is preferred that both thermoplastics are equivalent polyolefins. The pattern, coverage, and composition of the slip resistant coatings layers 12 and 32 need not be equivalent in this embodiment but both shall include at least one clean peelable pressure sensitive adhesive component. It is anticipated that somewhat different levels of ‘grip’ might be preferred when bonding is pressure activated for installation of the underlayment sheet and subsequently for walkability.

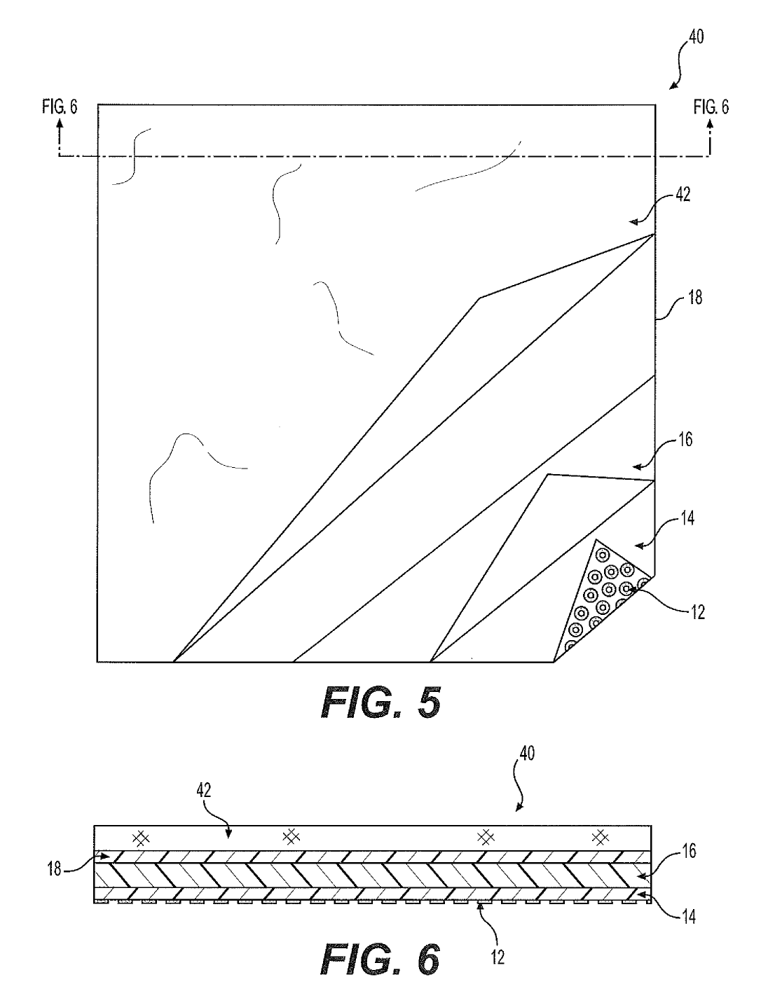

A further example of underlayment sheet 40 is illustrated in FIGS. 5 and 6. A nonwoven fabric 42 is laminated to the structure of underlayment 20. The nonwoven fabric 42 has a texture on the installer facing surface to achieve walkability by mechanical grip. A spun bound nonwoven fabric of basis weight greater than 18 gsm is preferred. The nonwoven layer 42 adds additional strength and bulk to the underlayment sheet 40 and affords the manufacturer the option of adjusting basis weights of both the nonwoven layer 42 and the woven fabric layer 16 to optimize strength and cost. In this example, layer 18 again does not have to exhibit a higher coefficient of friction than that of layer 14 but it must be capable of affixing or bonding the nonwoven fabric of layer 42 to the woven fabric of layer 16. It is preferred that layer 42 be laminated during extrusion of layer 18.

Coefficient of friction is used throughout this description to describe the characteristic that relates to the extent of slip resistance of the underlayment sheet surface. One common way to assess the coefficient of friction is to measure the slide angle. In this test, a specimen of fixed dimensions is affixed to a weighted sled of equivalent area dimensions. The sled is placed specimen down against a specified surface of an inclined plane which is raised from 0° slope at a fixed rate until the sled and specimen begin to slide down the plane. The slope angle at which the sled and specimen begin to slide is referred to as the ‘slide angle’. The tangent of the slide angle when expressed in radians is the static coefficient of friction. The values recorded in this patent document follow TAPPI T-548 and were recorded with a TMI model 32-25 Coefficient of Friction Tester using a 2.5″×2.5″ sled weighing 200 g. The smooth aluminum bed of the unit's inclining plane and thin 4″ wide strips of wood from fruit crates were used as test surfaces; the aluminum as a reference surface and the crate wood as a roof deck simulation surface. To demonstrate the pressure sensitive aspects of the slip resistant formulations described herein, specimens were repeat tested for slide angle after first applying a compressive force of several pounds to the sled with specimen to activate the pressure sensitive component to achieve temporary bonding to the slide test surface. Differences in excess of 3° between the first and second slide angle were considered indicative of ‘set’ performance.

Example 1 is representative of either underlayment sheet 10 or underlayment sheet 20 of FIGS. 1-3. A woven polyolefin fabric 16 is extrusion coated with a polyolefin on one face 14 and a slip resistant elastomer blend on the opposite face 18. A slip resistant coating 12 consisting of an aqueous dispersion of 70% of an acrylic polymer and 30% of a clean peelable pressure sensitive adhesive, commercially available as Micronax, was printed on the polyolefin layer 14 as an array of close packed 0.75″ diameter rings at the equivalent wet coverage of 10 gsm. Area coverage of layer 12 was 25%.

Example 2 is representative of underlayment sheet 40 of FIGS. 5-6. A woven polyolefin fabric 16 is extrusion coated with polyolefin 14 on one face and extrusion laminated spun bound polyolefin nonwoven fabric 42 with a polyolefin blend 18 on the opposite face. The polyolefin layer 14 was subsequently printed with a neat aqueous dispersion of clean peelable pressure sensitive adhesive as described above with the same close packed array of 0.75″ diameter rings at a nominal wet coverage of 12 gsm as the slip resistant layer 12.

Additional underlayment sheet materials were tested for slide angle as comparatives. These include both coated faces (14 and 18) of base woven fabric 16 of Example 1. A sample of 30 lb felt and several commercially available synthetic underlayment products claiming slip resistant capability are also included to demonstrate the novelty of this invention. For the Titanium UDL 30 material both the installer side (up) with Fiber Claw™ mechanical traction and the deck side with skid-resistant polymer were tested. The remaining materials were tested against their deck facing surface only. These results are compared in table 1. Several entries in table 1 include a second set of slide angle values identified as ‘after pressure’. These are provided to further elucidate the performance uniqueness of the underlayment sheet described herein associated with the increased ‘grip’ achieved through pressure activation.

TABLE 1

| | vs. metal | | vs wood | |
|---|---|---|---|---|
| | slide | equivalent | slide | equivalent |
| Material | angle, ° | COF | angle, ° | COF |
| base layer 14 | 15 | 0.268 | 14 | 0.249 |
| after pressure | 15 | 0.268 | 14 | 0.249 |
| base layer 18 | 31 | 0.601 | 28 | 0.532 |
| after pressure | 33 | 0.649 | 28 | 0.532 |
| example 1 | 33 | 0.649 | 28 | 0.532 |
| after pressure | 59 | 1.664 | 39 | 0.810 |
| example 1 | 46 | 1.036 | 36 | 0.727 |
| after pressure | 83 | 8.144 | 61 | 1.804 |
| 30 lb felt | 16 | 0.287 | 28 | 0.532 |
| after pressure | 17 | 0.306 | 27 | 0.510 |
| Titanium UDL 30 (up) | 15 | 0.268 | | |
| after pressure | 16 | 0.287 | | |
| Titanium UDL 30 (deck) | 29 | 0.554 | | |
| after pressure | 31 | 0.601 | | |
| Protec 120 | 25 | 0.466 | | |
| Protec 160 | 25 | 0.466 | | |
| Protectite Superior | 24 | 0.445 | | |
| Protectite Ultra | 25 | 0.466 | | |
| RhinoRoof | 23 | 0.424 | | |
| Alpha Protech | 18 | 0.325 | | |

The formation of a temporary bond between the clean peelable pressure sensitive component of the slip resistant layer 12 and the contacted surface will be limited to that of the contact area experiencing an external compressive force. The strength of that bond will depend upon the amount of force applied, the area coverage of layer 12 within the contact area, the concentration of the clean peelable pressure sensitive adhesive component(s), and to a limited extent the time the compressive force is applied. As evidenced by ‘after pressure’ slide angles of table 1 even a small force of several pounds can generate a significant temporary bond. Another measurement of the adhesive bond that is established is through a Peel Adhesion test. While a number of measurement protocols are known, one commonly referenced in the construction industry is that of ASTM D1970 for self-adhering sheet materials used as ‘steep’ roofing underlayment. ASTM 1970 established 1 lb_{f}/in width as the minimum adhesion to plywood at 75° F. for a roofing underlayment to qualify as self-adhering.

Peel adhesion values given in table 2 compare self-adhering flashing tapes to that of examples 1 and 2 when applied to a 1.5″ wide brass strip and rolled with a 5 lb roller. Specimens were peeled at a rate of 12″/min at a peel angle of approximately 180°. These results clearly demonstrate the temporary bond achieved with the clean peelable adhesive of layer 12 of this invention. Further it is evident that the strength of this bond though significant, is lower than that of a common self-adhering construction material. For clean peelable adhesive described herein, the peel force of the slip resistant layer when pressure activated is between 0.1 and 1 lb_{f}/in, and alternatively between 0.2 lb_{f}/in and 0.8 lb_{f}/in. The composition of layer 12 that achieves these levels of peel adhesion was found to include the clean peelable pressure sensitive adhesive component at concentrations between 10% and 100% and alternatively between 25% and 80% of the overall pressure sensitive adhesive mixture, with the balance of the pressure sensitive adhesive being an acrylic adhesive and optionally including anti-UV and antioxidant components among others. Another measure of the clean peelable adhesive component is its glass transition temperature (Tg). The Tg of the clean peelable adhesive is between about 0 and minus 120 degrees C., or alternatively between about minus 25 and minus 75 degrees C., or in one example, about minus 72 degrees C.

TABLE 2

| | specimen | Peel Force | | | |
|---|---|---|---|---|---|
| Material | width | Fₐᵥₑ | | Fₚₑₐₖ | |
| butyl adhesive tape | 1″ | 4.6 | lb/in | 6.4 | lb/in |
| copolymer adhesive tape | 1″ | 2.6 | lb/in | 3.4 | lb/in |
| example 1 | 1.5″ | 0.36 | lb/in | 0.38 | lb/in |
| example 2 | 1.5″ | 0.47 | lb/in | 0.55 | lb/in |

Other embodiments of the present invention will be apparent to those skilled in the art from consideration of the specification. It is intended that the specification and figures be considered as exemplary only, with a true scope and spirit of the invention being indicated by the following claim.

That which is claimed is:

1. A multilayer roofing underlayment sheet comprising:
a structural sheet layer formed of a flexible layer of fabric or paper or a composite thereof, the structural sheet layer having a top side and a bottom side;
first and a second water impermeable thermoplastic layers affixed on the top and bottom sides of the structural layer respectively;
a first clean peelable pressure sensitive adhesive coating layer on one of the water impermeable thermoplastic layers on the opposite side of the water impermeable thermoplastic layer from the structural layer.

2. A multilayer roofing underlayment sheet as described in claim 1, wherein the clean peelable pressure sensitive adhesive coating layer covers at least 5% of the surface of the water impenetrable thermoplastic layer on which it is coated.

3. A multilayer roofing underlayment sheet as described in claim 1, wherein the clean peelable pressure sensitive adhesive coating layer covers about 10% to 80% of the surface of the water impermeable thermoplastic layer on which it is coated.

4. A multilayer roofing underlayment sheet as described in claim 1, wherein the clean peelable pressure sensitive adhesive coating layer covers between about 25% and 80% of the surface of the water impermeable thermoplastic layer on which it is coated.

5. A multilayer roofing underlayment sheet as described in claim 1,
further comprising a second clean peelable pressure sensitive adhesive coating layer, and the first and second clean peelable pressure sensitive adhesive coating layers are on opposites sides of both the first and second water impenetrable thermoplastic layers,
whereby the clean peelable pressure sensitive adhesive coating layers are on both of the top and bottom sides of the underlayment sheet.

6. A multilayer roofing underlayment sheet as described in claim 1,
wherein the structural sheet layer is comprised of a nonwoven fabric.

7. A multilayer roofing underlayment sheet as described in claim 1,
wherein the structural sheet layer is comprised of a woven fabric.

8. A multilayer roofing underlayment sheet as described in claim 1,
wherein the peel force of the clean peelable pressure sensitive adhesive coating layer, after pressure activation, is between about 0.1 to 1 lbf/in.

9. A multilayer roofing underlayment sheet as described in claim 1,
wherein the peel force of the clean peelable pressure sensitive adhesive coating layer, after pressure activation, is between about 0.2 and 0.8 lbf/in.
